(19) United States
(12) Patent Application Publication
(10) Pub. No.: US 2012/0243726 A1
(43) Pub. Date: Sep. 27, 2012

(54) EARPHONE

(75) Inventors: Mitsuru Hosoo, Shinagawa (JP); Tomonari Kaneko, Ebina (JP); Yoshimi Aoyagi, Shinagawa (JP)

(73) Assignees: S'NEXT CO., LTD., Shinagawa-ku ,Tokyo (JP); MOLEX INCORPORATED, Lisle, IL (US)

(21) Appl. No.: 13/392,747

(22) PCT Filed: Aug. 25, 2010
(86) PCT No.: PCT/US2010/046683

§ 371 Date: Jun. 13, 2012

(30) Foreign Application Priority Data
Aug. 25, 2009 (JP) 2009-194328
Aug. 25, 2009 (JP) 2009-194633
Aug. 25, 2009 (JP) 2009-194644

(51) Int. Cl. H04R 1/10

(52) U.S. Cl. 381/380

(57) ABSTRACT

An earphone is disclosed. The earphone comprises an external auditory meatus insertion member, a casing and a driver unit. The external auditory meatus insertion member has a part which is insertable into an external auditory meatus. The external auditory meatus insertion member is detachable from the casing. The driver unit is disposed within the casing to generate sounds. The the external auditory meatus insertion member further includes an elastically deformable soft insertion member and a highly rigid hard insertion member.

### REFERENCE TO RELATED APPLICATIONS

The Present Application claims priority to prior-filed Japanese Patent Application Nos. 2009-194328, entitled “Ear Pad And Earphone Having The Same;” 2009-194633, entitled “Earphone;” and 2009-194644, entitled “Earphone.” Each of these aforementioned Applications was filed with the Japanese Patent Office on 25 Aug. 2009. Further, the contents of each of these aforementioned Applications are fully incorporated herein in their entireties.

### BACKGROUND OF THE PRESENT APPLICATION

The Present Application relates to an earphone having an external auditory meatus insertion member at least a part of which is inserted into an external auditory meatus.

Conventionally, as an earphone attached to an auricle when it is used, there has been known an earphone, which does not have a projection portion to be inserted into the external auditory meatus, that is, so-called an earphone-type headphone. An example of this type of earphone is disclosed in Japanese Utility Model Application No. H4-050718. This type of earphone has, for example, a dynamic-type driver unit and generates sounds by vibrating a diaphragm in the driver unit.

FIG. 7 is a cross section illustrating the structure of a conventional earphone. Referring to FIG. 7, a rear housing 813 of the earphone is equipped with a driver unit 841 in the inside of the rear housing 813. Further, a ring-shaped front housing 812 fit in the tip (the lower end in FIG. 7) of the rear housing 813 fixes the driver unit 841. Moreover, a duct-shaped cable holding portion 815 extends from the rear surface of the rear housing 813 and houses an electric wire cable 891 one end of which is connected to the driver unit 841 and the other end of which is connected to audio equipment, which is not shown, such as a music player, a television, a radio, or a video recorder, which is not shown.

Further, the driver unit 841 includes a magnet 843, a plate 844, and a yoke 845, which form a magnetic circuit, and a diaphragm 846 and a voice coil 847, which form a vibration system. Specifically, the plate 844 and the yoke 845 are secured to both sides of the disk-shaped magnet 843. The magnet 843 is, for example, a samarium cobalt magnet. Moreover, a magnetic gap is formed in a space to which the plate 844 and the yoke 845 are opposed and the voice coil 847 secured to the diaphragm 846 is inserted into the magnetic gap. The diaphragm 846 is, for example, a polyester film. A meshed protection plate 848, having a lot of relatively large openings, is disposed in the front of the earphone, namely in front (the lower side in FIG. 7) of the diaphragm 846.

A through-hole 849 is formed in the center of the magnet 843, the plate 844, and the yoke 845, and a resistor material 871 made of urethane foam or the like is buried in the through-hole 849. Further, a plurality of holes 870 are formed in the driver unit 841.

When the earphone is attached into the concave portion of the auricle, a protection plate 848 disposed in the front of the earphone is opposed to the entrance of the external auditory meatus, and sounds generated by the vibration of the diaphragm 846 impinge on the inside of the external auditory meatus through the openings of the protection plate 848 and reach the eardrum.

Nevertheless, in the conventional earphone, the earphone is attached to the concave portion of the auricle, which leads to poor wearability. Particularly in cases where a user is not in a resting state such as during walking, the earphone sometimes falls off the auricle. Moreover, the poor wearability destabilizes the positional relationship with the external auditory meatus and thus destabilizes the sound volume and sound quality of the sounds impinging on the external auditory meatus. Accordingly, in recent years, there has been provided an earphone having an ear pad made of soft rubber or the like having elasticity so that the ear pad is inserted into the external auditory meatus. This type of earphone is attached by inserting the flexible ear pad into the external auditory meatus and therefore is able to be reliably attached to the auricle and does not fall off the auricle during walking. Moreover, the ear pad is made of material having elasticity and therefore is easily elastically deformable according to the shape of the external auditory meatus, thereby providing good wearing feeling.

When the flexible ear pad is inserted into the external auditory meatus, however, the ear pad pressed and deformed by the external auditory meatus blocks the communication between the inside and the outside of the external auditory meatus, thereby inhibiting the sounds, which impinged on the external auditory meatus from the earphone, from being let out to the outside. This deteriorates so-called sound clearness and generates muffled or unclear sounds or the like, thus reducing the sound quality. Moreover, resonance of the ear pad sometimes occurs in a low frequency band.

### SUMMARY OF THE PRESENT APPLICATION

Therefore, the Present Application has been made to solve the foregoing problems of the conventional earphone and has an object to provide an earphone, wherein the external auditory meatus insertion member, at least a part of which is inserted into the external auditory meatus, is detachable from the casing, so that the external auditory meatus insertion member made of soft material is able to be attached to the casing in the case of making much of wearability and so that the external auditory meatus insertion member made of hard material is able to be attached to the casing in the case of making much of the sound quality, whereby the earphone is able to appropriately adapt to a wide variety of usages, to provide high wearability and good wearing feeling and to reproduce sharp low sounds and clear mid and high sounds with the sounds favorably let out to the outside so as to provide high sound quality.

In order to achieve the above object, the Present Application provides an earphone, comprising: an external auditory meatus insertion member at least a part of which is insertable into an external auditory meatus; a casing from which the external auditory meatus insertion member is detachable; and a driver unit which is disposed within the casing to generate sounds, wherein: the external auditory meatus insertion member includes an elastically deformable soft insertion member and a highly rigid hard insertion member; and the soft insertion member and the hard insertion member are selectively attached to the casing.

In another earphone according to the Present Application, further the casing is made of metal and includes a truncated cone-like front space, which is formed in front of the driver unit, a sound guide hole, which is in communication with a front end of the front space to cause sounds to impinge on the external auditory meatus, and a cylindrical rear space, which is formed behind the driver unit; and the rear space includes a tone control hole, which opens facing laterally.

In still another earphone according to the Present Application, further a surface opposed to the driver unit in the rear space is a flat surface; the rear space has an air control hole which opens facing laterally; and the front space has an air control hole which opens facing forward.

In still another earphone according to the Present Application, further the outline of the casing and the outline of the external auditory meatus insertion member attached to the casing are axisymmetric with respect to an axis extending in a longitudinal direction.

In further another earphone according to the Present Application, further the soft insertion member includes a cylindrical body portion, in the center of which a sound guide hole is formed, and an elastically deformable portion, which is connected to the tip of the body portion and slantingly spreads from the tip of the body portion toward the rear end thereof; the elastically deformable portion includes a plurality of slit-shaped openings radially extending when viewed from the tip side of the body portion; and the body portion includes grooves axially extending and formed in places respectively corresponding to the openings in an outer peripheral surface of the body portion; and the openings overlap with the grooves corresponding thereto in a state where the elastically deformable portion is deformed and pressed against the outer peripheral surface of the body portion.

In still another earphone according to the Present Application, further the hard insertion member is made of metal and includes a cylindrical body portion, in the center of which a sound guide hole is formed, and a bulge whose outer surface slantingly spreads from the tip of the body portion toward the rear end thereof; and the bulge deforms at least a part of the inner surface of the external auditory meatus when inserted into the external auditory meatus.

According to the Present Application, in the earphone, the external auditory meatus insertion member at least a part of which is inserted into the external auditory meatus is detachable from the casing. Thereby, the external auditory meatus insertion member made of soft material is able to be attached to the casing in the case of making much of wearability, and the external auditory meatus insertion member made of hard material is able to be attached to the casing in the case of making much of the sound quality. Therefore, the earphone is able to appropriately adapt to a wide variety of usages, to provide high wearability and good wearing feeling and to reproduce sharp low sounds and clear mid and high sounds with the sounds favorably let out to the outside so as to improve the sound quality.

### BRIEF DESCRIPTION OF THE FIGURES

The organization and manner of the structure and operation of the Present Application, together with further objects and advantages thereof, may best be understood by reference to the following Detailed Description, taken in connection with the accompanying Figures, wherein like reference numerals identify like elements, and in which:

FIG. 1 is a cross-section illustrating use of an earphone according to the Present Application, taken along Line A-A of FIG. 2C;

FIG. 2 is a five-side view illustrating the earphone of FIG. 1, wherein FIG. 2A is from the top; FIG. 2B, the left side; FIG. 2C, the rear; FIG. 2D, the right side; and FIG. 2E, the front;

FIG. 3 is a four-side view of an ear pad according to the Present Application, wherein FIG. 3A is from the left side; FIG. 3B, the rear; FIG. 3C, the right side; and FIG. 3D, the front;

FIG. 4 is a cross-section of the ear pad of FIG. 3, wherein FIG. 4A is a cross-section taken along Line B-B of FIG. 3B; and FIG. 4B is a cross-section taken along Line C-C of FIG. 3B;

FIG. 5 is a cross-section illustrating use of an earphone according to the Present Application, taken along Line D-D of FIG. 6C;

FIG. 6 is a five-side view illustrating the earphone of FIG. 5, wherein FIG. 6A is from the top; FIG. 6B, the left side; FIG. 6C, the rear; FIG. 6D, the right side; and FIG. 6E, the front; and

FIG. 7 is a cross-sectional view illustrating the structure of a conventional earphone.

### DESCRIPTION OF THE PREFERRED EMBODIMENTS

While the Present Application may be susceptible to embodiment in different forms, there is shown in the Figures, and will be described herein in detail, specific embodiments, with the understanding that the disclosure is to be considered an exemplification of the principles of the Present Application, and is not intended to limit the Present Application to that as illustrated.

In the illustrated embodiments, directional representations—i.e., up, down, left, right, front, rear and the like, used for explaining the structure and movement of the various elements of the Present Application, are relative. These representations are appropriate when the elements are in the position shown in the Figures. If the description of the position of the elements changes, however, it is assumed that these representations are to be changed accordingly.

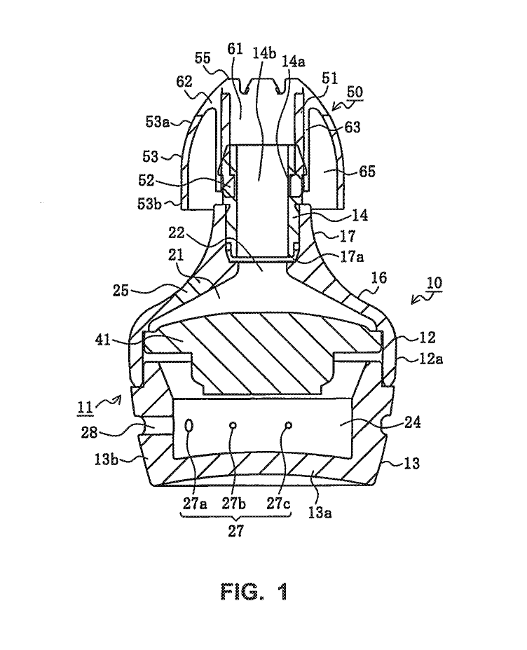

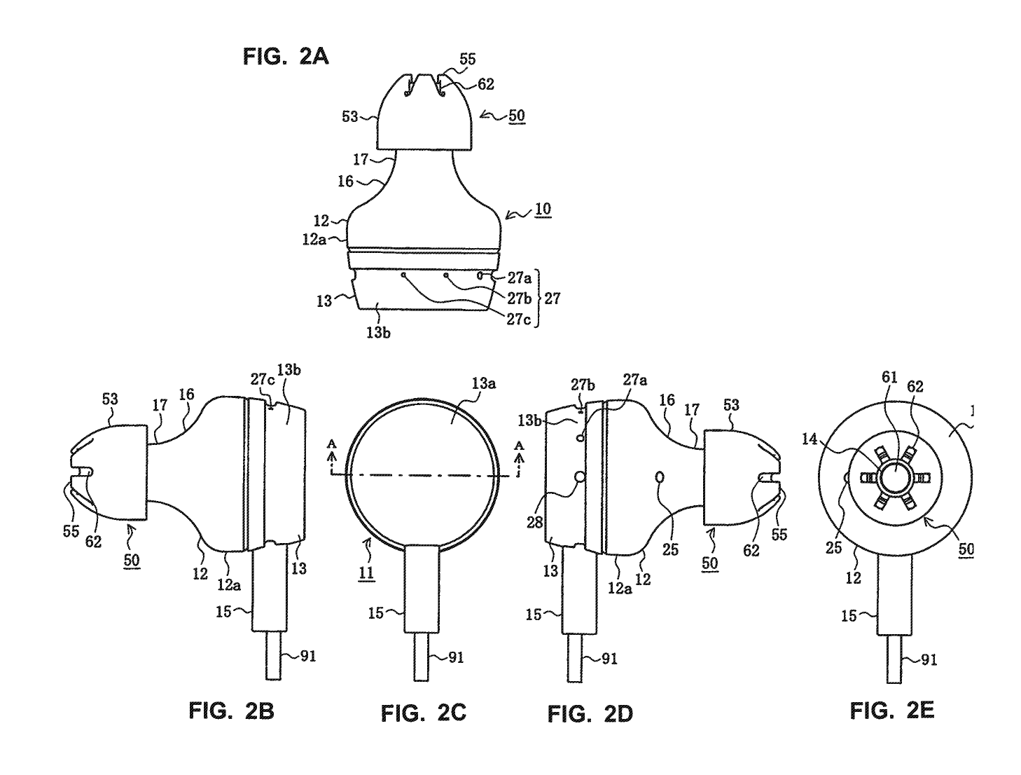

Referring to FIGS. 1-2, an earphone 10 is attached to the auricle of a user when used and is a compact audio generator, which is driven by an audio signal as an electrical signal and reproduces the audio signal. Further, the earphone 10 has a casing 11 as a housing, which incorporates a driver unit 41 as a speaker unit for generating sounds by reproducing audio signals, and as a first example of of use, an ear pad 50 as an external auditory meatus insertion member, which is mounted on the casing 11 and is able to be inserted at least in its tip portion 55 into the external auditory meatus of the user.

The casing 11 includes a front casing 12 located on the front side thereof, and a truncated cone-like rear casing 13 connected to the rear side of a base 12a of the front casing 12. Further, as shown in FIG. 1, the driver unit 41 is held inside the casing 11 with its front and rear (the upper side and the lower side in FIG. 1) interposed between the front casing 12 and the rear casing 13. The driver unit 41 is of a so-called dynamic type and has the same structure as the driver unit 841 of the conventional earphone described in the paragraphs of “Description of the Related Art.” Specifically, the description of the driver unit 841 of the conventional earphone is invoked as the description of the driver unit 41.

Moreover, a rear surface portion 13a which closes the rear surface of the rear casing 13 is a substantially plate-like member, thereby forming a rear space 24 behind (downward in FIG. 1) the driver unit 41 in the casing 11. The rear space 24 is a space generally having a cylindrical shape and more specifically having a combined shape of a truncated cone and a cylinder. Although the surface opposed to the driver unit 41 in the rear space 24 is an inner surface of the rear surface portion 13a and a flat surface opposed to the diaphragm of the driver unit 41, the surface may be a gently curved surface, which is slightly bent, having a large radius of curvature as shown in FIG. 1. Although the casing 11 is made of metal such as, specifically, aluminum, steel, copper or an alloy thereof, the casing 11 may be made of hard resin, crystal, or the like having a relatively large specific gravity.

Further, the rear casing 13 is provided with an upper end, attached thereto, of a cylindrical cable holding portion 15 which encloses and holds a part of an electric wire cable 91, one end of which is connected to the driver unit 41. The cable holding portion 15 may be formed integrally with the rear casing 13. Further, the electric wire cable 91 extends from the lower end of the cable holding portion 15. In FIG. 1, a picture of the electric wire cable 91 is drawn only in a part adjacent to the cable holding portion 15 and other parts are omitted for convenience of illustration. The other end, which is not shown, of the electric wire cable 91 is connected to audio equipment, which is not shown, such as a music player, a television, a radio, or a video recorder.

The front casing 12 includes a truncated cone-like conical portion 16, which projects forward from the base 12a, and a cylindrical insertion part mounting portion 17, which projects from the tip of the conical portion 16, in addition to the cylindrical base 12a. The conical portion 16 has a tip whose diameter is smaller than its base end (a portion connected to the base 12a), thereby forming a front space 21, which is a truncated cone-like space, in front of (the upper side in FIG. 1) the driver unit 41 in the casing 11. Further, in the insertion part mounting portion 17, there is formed a casing sound guide hole 22 as a sound guide hole which is a cylindrical opening whose rear end is in communication with the front space 21 and whose front end is open. Thereby, sounds generated by the driver unit 41 impinge on the external auditory meatus of a user through the front space 21 and the casing sound guide hole 22. The conical portion 16 is formed in such a way that the central axis of the tip coincides with the central axis of the base end. Therefore, except the cable holding portion 15 and the electric wire cable 91, the outline of the earphone 10 including the casing 11 and the ear pad 50 is circular when viewed from the front as shown in FIG. 2E and axisymmetric with respect to the axis when viewed laterally as shown in FIGS. 2A, 2B, and 2D.

Moreover, a front air duct 25 as an air control hole, functioning as an air vent, is formed in the conical portion 16 of the front casing 12. The front air duct 25 is a hole having a circular cross section, which is formed so as to pass through the conical portion 16, and communicating the front space 21 with the outside to enable the air in the front space 21 to be vented to the outside. The front air duct 25 is formed in a portion near the base 12a in the conical portion 16, that is, a surface portion which faces forward. In other words, the front air duct 25 is formed so as to face forward to enable the air in the front space 21 to be vented forward. Although the diameter of the front air duct 25 is, for example, 1.2 [mm], the diameter may be changed according to the performance of the driver unit 41, the size of the front space 21, or the like.

Moreover, a rear air duct 28 as an air control hole, functioning as an air vent, and a first control hole 27a, a second control hole 27b and a third control hole 27c as tone control holes are formed in the cylindrical side face portion 13b of the rear casing 13. In cases where the first control hole 27a, the second control hole 27b and the third control hole 27c are collectively described, these holes are referred to as the tone control hole 27.

The rear air duct 28 is a hole having a circular cross section, which is formed so as to pass through the side face portion 13b of the rear casing 13, and communicating the rear space 24 with the outside to enable the air in the rear space 24 to be vented to the outside. The rear air duct 28 is formed so as to face laterally to enable the air in the rear space 24 to be vented laterally. Although the diameter of the rear air duct 28 is preset so as to be equal to the front air duct 25, the diameter may be changed according to the performance of the driver unit 41, the size of the rear space 24, or the like. The air vents having the same diameter, namely, the front air duct 25 and the rear air duct 28 are disposed in the front space 21 and the rear space 24, respectively, as described above, whereby it is possible to correct sound distortion and echo and to reduce a load on the diaphragm of the driver unit 41.

Moreover, the first control hole 27a, the second control hole 27b and the third control hole 27c are holes each having a circular cross section formed so as to pass through the side face portion 13b of the rear casing 13 and so as to face laterally, and communicating the rear space 24 with the outside. In addition, the first control hole 27a, the second control hole 27b and the third control hole 27c are adjacent to the rear air duct 28 and disposed in line on the same circumference in the rear casing 13. Further, these holes are formed so that the diameter of the first control hole 27a is smaller than the diameter of the rear air duct 28 and the diameter of the second control hole 27b is smaller than the first control hole 27a and the diameter of the third control hole 27c is smaller than the second control hole 27b. The diameter of the second control hole 27b and the third control hole 27c may be formed equal.

The diameter of the first control hole 27a is, for example, 0.8 [mm]. With the setting of the diameter of the first control hole 27a to this value, it is possible to control the sounds in a frequency band around 1200 [Hz], to provide smoother frequency responses, and to improve the sound quality. Further, the diameter of the second control hole 27b is, for example, 0.4 [mm]. With the setting of the diameter of the second control hole 27b to this value, it is possible to control the sounds in a frequency band around 200 [Hz], to provide smoother frequency responses, and to improve the sound quality. Further, the diameter of the third control hole 27c is, for example, less than 0.4 [mm]. With the setting of the diameter of the third control hole 27c to this value, it is possible to control the sounds of a frequency band lower than the second control hole 27b, to provide smoother frequency responses, and to improve the sound quality.

If the diameter of the second control hole 27b is set to be equal to the diameter of the third control hole 27c such as, for example, a case where these holes are two second control holes 27b, the sounds in a frequency band around 200 [Hz] are controlled with a response different from the case where one control hole is used.

Although there are provided the three tone control holes 27, the first control hole 27a, the second control hole 27b and the third control hole 27c in the shown example, the number of tone control holes 27 may be either one or two, or more than four. Moreover, the diameter of the tone control hole 27 may be changed according to the frequency band of the sounds to be controlled. More specifically, to control the sounds in a low frequency band, the diameter of the tone control hole 27 is decreased. To control the sounds in a high frequency band, the diameter of the tone control hole 27 is increased.

In other words, these tone control holes 27 determine the range to be controlled by the diameters of the holes, control the characteristics by the number of the holes, and control the air balance which leads to the feeling of openness in the sounds.

Further, the rear air duct 28 and the tone control holes 27 formed in the side surface portion 13b of the rear casing 13 are disposed on the same circumference, by which the control holes are disposed in the positions the same in distance from the driver unit, thus enabling the sounds to be controlled more effectively.

Further, the casing 11 houses the driver unit 41 and includes the front space 21 and the rear space 24 in front of and behind the driver unit 41, respectively. The casing 11 is made of metal which is highly rigid material having a specific gravity greater than that of resin or the like. Therefore, the casing 11 favorably functions as a sound space for the front space 21 and the rear space 24, thereby making low sounds solid and mid and high sounds clear. Moreover, the outline of the casing 11 is axisymmetric with respect to the axis when viewed laterally and therefore the shape of the front space 21 and the shape of the rear space 24 are axisymmetric with respect to the axis, thereby enabling generation of undistorted sounds.

Further, the ear pad 50 is mounted on the insertion mounting portion 17 via a mounting adapter 14. The mounting adapter 14 is a cylindrical member made of the same material as the casing 11, and the lower end of the mounting adapter 14 is inserted into the inner peripheral surface of the insertion mounting portion 17, namely an accommodating recess portion 17a, which is formed on the peripheral surface of the casing sound guide hole 22. Although the mounting adapter 14 may be fixed to the accommodating recess portion 17a by fitting the lower end of the mounting adapter 14 into the accommodating recess portion 17a, it is preferable to fix the mounting adapter 14 to the accommodating recess portion 17a by forming a thread groove on the lower end of the mounting adapter 14 and the accommodating recess portion 17a and screwing the lower end of the mounting adapter 14 into the accommodating recess portion 17a. Moreover, there is formed an adapter sound guide hole 14b, as a sound guide hole which is a cylindrical opening which is open at front and rear ends, in the mounting adapter 14. The inside diameter of the adapter sound guide hole 14b is preferably equal to the value of the inside diameter of the casing sound guide hole 22.

Further, the ear pad 50 is a soft insertion member, which is made of soft elastically deformable material such as, for example, silicon rubber, and is an integrally formed member, including a cylindrical body portion 51, which is fit around the mounting adapter 14, and a cap portion 53 as an elastically deformable portion, which slantingly spreads from the tip of the body portion 51 toward the rear end thereof. At the rear end of the body portion 51, there is formed a thick flange-like engaging convex portion 52 which projects inward. The engaging convex portion 52 engages with a grooved engaging concave portion 14a, which is formed in the mounting adapter 14, to prevent the ear pad 50 from being detached from the mounting adapter 14.

The ear pad 50 has a mushroom- or umbrella-like shape as a whole. At a tip portion 55 of the ear pad 50, the tip of the body portion 51 is connected to the tip of the cap portion 53 and a cavity portion 65 is formed between the outer peripheral surface of the body portion 51 and the inner peripheral surface of the cap portion 53. Further, a pad sound guide hole 61 as a sound guide hole, which is a cylindrical opening with its front and rear ends open, is formed in the center of the body portion 51. The pad sound guide hole 61 is in communication with the casing sound guide hole 22 via the adapter sound guide hole 14b with the ear pad 50 mounted on the insertion part mounting portion 17 via the mounting adapter.

Moreover, the cap portion 53 includes a truncated cone-like front half portion 53a, which spreads rearward, and a cylindrical rear half portion 53b, which extends in the rear direction from the rear end of the front half portion 53a. The cap portion 53 is thinner than the body portion 51 and is flexible. Therefore, the cap portion 53 is elastically deformed easily by receiving a force. Accordingly, when the ear pad 50 is inserted into the external auditory meatus, the cap portion 53 is elastically deformed so as to fit the inner surface shape of the external auditory meatus without damaging the external auditory meatus, and the cap portion 53 comes in close contact with the inner surface of the external auditory meatus without applying a reaction force to the inner surface, thereby providing good wearing and fit feelings, and the like.

Further, a plurality of (six in the shown example) radially extending slit-shaped openings 62 are formed in the front half portion 53a of the cap portion 53 when viewed from the tip side. When the user wears the earphone 10, the ear pad 50 is inserted into the external auditory meatus and the cap portion 53 blocks the communication between the inside and the outside of the external auditory meatus. The inside of the external auditory meatus, however, is in communication with the outside thereof due to the presence of the openings 62. Therefore, even in the state where the user wears the earphone 10, external environmental sounds such as an alarm impinge on the inside of the external auditory meatus and reach the eardrum, so that the safety is not reduced. Moreover, the air in the external auditory meatus is vented to the outside through the openings 62, thereby reducing the sense of pressure, muffled quality, and the like of the sounds which impinged on the inside of the external auditory meatus passing through the casing sound guide hole 22 and the pad sound guide hole 61 from the driver unit 41. This improves the sharpness of low sounds and provides clear mid and high sounds. Further, the sounds from the driver unit 41 do not press the eardrum and therefore the earphone 10 is also favorable to the health.

In the outer peripheral surface of the body portion 51, there are formed pad grooves 63 as grooves each extending in the fore-and-aft direction, namely in the axial direction of the body portion 51 in the places corresponding to the openings 62, respectively. Therefore, even in cases where the cap portion 53 is deformed and pressed against the outer peripheral surface of the body portion 51 when the ear pad 50 is inserted into the external auditory meatus, the openings 62 overlap with the pad grooves 63 corresponding thereto, thereby maintaining the communication between the inside and the outside of the external auditory meatus.

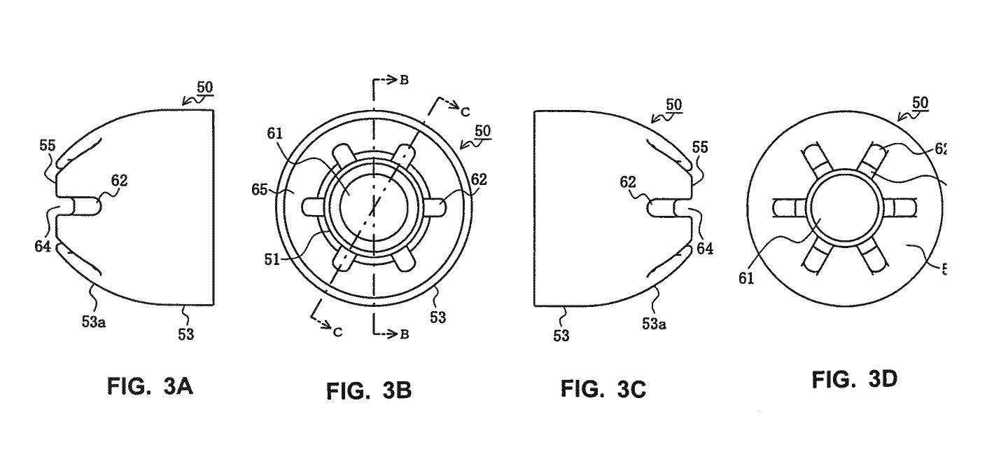

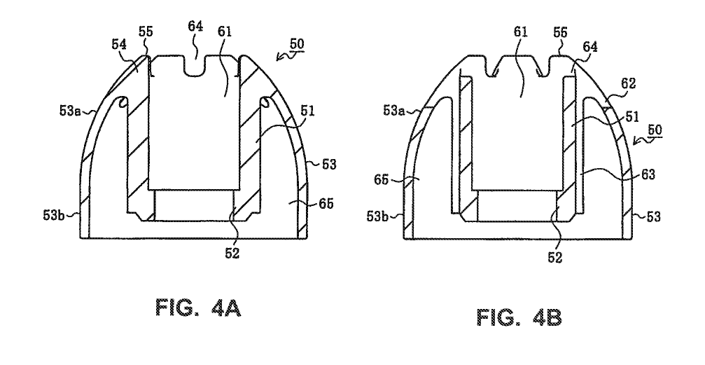

Referring to FIGS. 3-4, which illustrate the configuration of the ear pad 50, the tip of the body portion 51 is connected to the tip of the cap portion 53 via a tip connecting portion 54, and the tip of each opening 62 is in communication with the tip of the pad sound guide hole 61 via a communication recess 64. Further, in the circular tip portion 55 of the ear pad 50, the tip connecting portions 54 and the communication recesses 64 are disposed alternately. Accordingly, the sounds, which impinged on the inside of the external auditory meatus passing through the casing sound guide hole 22, adapter sound guide hole 14b and the pad sound guide hole 61 from the driver unit 41, partially exit from the openings 62 to the outside via the communication recesses 64. Therefore, the sense of pressure, muffled quality, and the like of the sounds are reduced, which thereby makes the sounds clear.

The tip connecting portion 54 is thicker than the cap portion 53 as shown in FIG. 4A and therefore has higher rigidity than the cap portion 53 and is undeformable. Moreover, the communication recesses 64 each disposed between the tip connecting portions 54 are formed so as to be recessed rearward from the tip edge of the tip portion 55, namely the tip edge of the tip connecting portion 54, viewed from the side surface. Accordingly, even in cases where the cap portion 53 is deformed when the ear pad 50 is inserted into the external auditory meatus, the communication recess 64 is not blocked, but the communication between the pad sound guide hole 61 and the openings 62 is maintained. As described above, even in cases where the cap portion 53 is deformed and pressed against not only the outer peripheral surface of the body portion 51, but the surface of the conical portion 16, the openings 62 and the pad grooves 63 are in communication with each other. Therefore, a sound passage is stably secured from the pad sound guide hole 61 through the communication recesses 64, the openings 62 and the pad grooves 63 to the outside, whereby the sense of pressure, muffled quality, and the like of the sounds are stably reduced and clear sounds are maintained.

Moreover, as shown in FIG. 4B, the tips of the openings 62 are preferably formed so as to be continued to the tips of the pad grooves 63, respectively. In this instance, even in cases where the cap portion 53 is significantly deformed, the communication between the openings 62 and the pad grooves 63 is stably maintained.

Further, in the front half portion 53a of the cap portion 53, the plurality of slit-shaped openings 62 radially extending when viewed from the front are formed as shown in FIG. 3D. Accordingly, the rigidity of the front half portion 53a is reduced and deformable due to the presence of the openings 62. Therefore, when the ear pad 50 is inserted into the external auditory meatus, not only the front half portion 53a, but also the entire cap portion 53 is flexibly and elastically deformed so as to fit to the inner surface shape of the external auditory meatus. Thus, the Present Application does not damage the external auditory meatus, but provides high safety. Further, the cap portion 53 comes in close contact with the inner surface of the external auditory meatus without applying a reaction force thereto, thereby providing a good wearing feeling, fit feeling, and the like, as well as preventing the earphone 10 from being detached from the ear pinna.

In the shown example, the number of the openings 62, of the pad grooves 63, and of the communication recesses 64 is six. It, however, does not always need to be six, but may be either five or less or seven or greater.

As described above, the wearability of the earphone 10 increases by mounting the ear pad 50 made of soft material on the insertion mounting portion 17 via the mounting adapter 14. Therefore, the earphone with the ear pad 50 made of soft material is favorable for use in cases where a user performs activities such as, for example, walking. Moreover, the inside of the external auditory meatus is communicated with the outside thereof due to the presence of the openings 62 or the like as described above, and therefore external environmental sounds, such as an alarm, impinge on the inside of the external auditory meatus and reach the eardrum, thereby achieving good sound quality without reducing the safety.

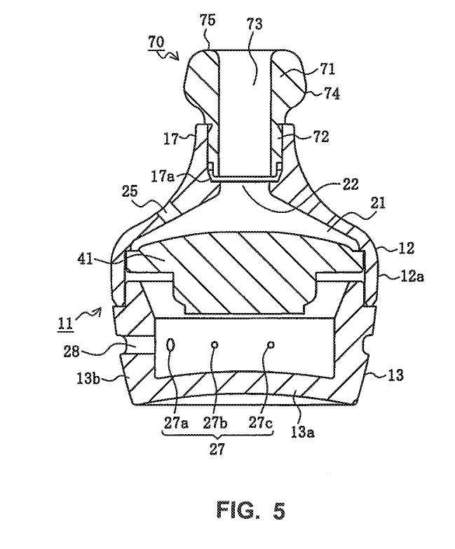

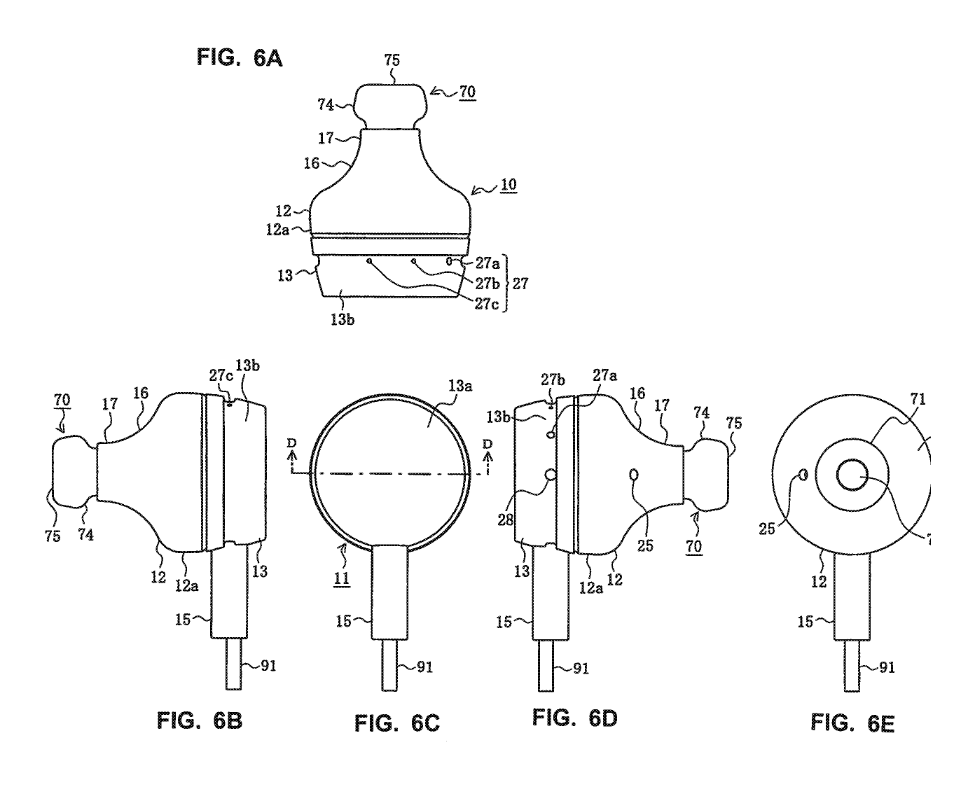

Referring to FIGS. 5-6, an ear piece 70, as an external auditory meatus insertion member, at least a tip portion 75 of which is insertable into the external auditory meatus of the user, is mounted on the casing 11. The ear piece 70 is a hard insertion member and made of the same metal or the like as the casing 11, namely highly-rigid hard material having a large specific gravity.

Further, the ear piece 70 is an integrally formed member and includes a cylindrical body portion 71 and a thick bulge 74 whose outer surface slantingly spreads from the tip of the body portion 71 toward the rear end thereof. A part extending rearward from the bulge 74 of the body portion 71 is a mounting portion 72. The mounting portion 72 is inserted into the inner peripheral surface of the insertion mounting portion 17 of the casing 11, namely the accommodating recess portion 17a, which is formed on the peripheral surface of the casing sound guide hole 22. Although the ear piece 70 may be fixed to the accommodating recess portion 17a by fitting the mounting portion 72 into the accommodating recess portion 17a, it is preferable to fix the ear piece 70 to the accommodating recess portion 17a by forming a thread groove on the mounting portion 72 and the accommodating recess portion 17a and screwing the mounting portion 72 into the accommodating recess portion 17a.

Further, there is formed a piece sound guide hole 73 as a sound guide hole which is a cylindrical opening open at front and rear ends in the center of the body portion 71. With the ear piece 70 mounted on the insertion mounting portion 17, the piece sound guide hole 73 is in communication with the casing sound guide hole 22. The inside diameter of the piece sound guide hole 73 is preferably equal to the value of the inside diameter of the casing sound guide hole 22.

The bulge 74 has a truncated cone-like outline and the outside diameter of the tip portion 75 is the smallest in the bulge 74 and increases toward the lower side. Specifically, the bulge 74 has a tapered outer surface and therefore is able to be easily inserted into the external auditory meatus. The largest outside diameter of the bulge 74 is preferably greater than the outside diameter of the upper end of the insertion mounting portion 17 of the casing 11.

Moreover, except the cable holding portion 15 and the electric wire cable 91, the outline of the earphone 10 including the casing 11 and the ear piece 70 is circular when viewed from the front as shown in FIG. 6E and axisymmetric with respect to the axis when viewed laterally as shown in FIGS. 6A, 6B, and 6D.

Further, when inserted into the external auditory meatus, the bulge 74 of the ear piece 70 is deformed by pressing the inner surface of the external auditory meatus, so that at least a part of the inner surface of the external auditory meatus is in close contact with the outer surface of the bulge 74. In this case, the outer surface of the bulge 74 is tapered and therefore the inner surface of the external auditory meatus is able to be smoothly deformed when the bulge 74 is inserted into the external auditory meatus, thereby preventing the external auditory meatus from being damaged and providing close contact of the inner surface of the external auditory meatus with the outer surface of the bulge 74 so as to provide good wearing and fit feelings and the like.

In addition, the ear piece 70 including the bulge 74 is formed of highly rigid hard material having a large specific gravity, and therefore the ear piece 70 does not resonate with sounds from the driver unit 41. Thus, the sound quality increases. Moreover, when the bulge 74 is inserted into the external auditory meatus, the piece sound guide hole 73 is not deformed. Therefore, the sounds from the driver unit 41 impinge on the external auditory meatus without sound distortion, by which the sound quality increases.

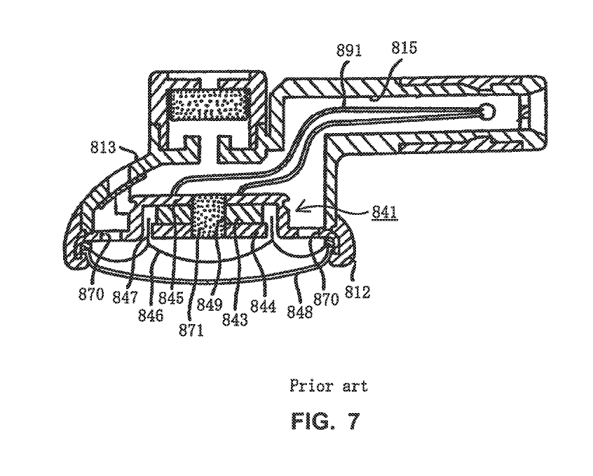

As described hereinabove, in FIGS. 6-7, the earphone 10 includes the external auditory meatus insertion member at least a part of which is insertable into the external auditory meatus, the casing 11 from which the external auditory meatus insertion member is detachable, and the driver unit 41 which is disposed in the casing 11 to generate sounds, wherein the external auditory meatus insertion member includes the elastically deformable ear pad 50 and the highly rigid ear piece 70 and wherein the ear pad 50 and the ear piece 70 are selectively attached to the casing 11.

This enables the user to select the ear pad 50 or the ear piece 70 appropriately and to mount it on the casing 11 according to the usage of the earphone 10. For example, the user is allowed to select the ear pad 50 in the case of making much of wearability such as in walking outdoors or to select the ear piece 70 in the case of making much of the sound quality such as in listening to music in a room. Therefore, the earphone is able to appropriately adapt to a wide variety of usages, to provide high wearability and good wearing feeling, and to provide high sound quality.

Moreover, the casing 11 is made of metal and includes the truncated cone-like front space 21, which is formed in front of the driver unit 41, the casing sound guide hole 22, which is in communication with the front end of the front space 21 to cause sounds to impinge on the external auditory meatus, and the cylindrical rear space 24, which is formed behind the driver unit 41. The rear space 24 includes the tone control holes 27, which open facing laterally.

As described above, the casing 11 houses the driver unit 41 and includes the front space 21 and the rear space 24 in front of and behind the driver unit 41, respectively. Further, the casing 11 is made of metal which is highly rigid material having a large specific gravity. Therefore, the casing 11 favorably functions as a sound space for the front space 21 and the rear space 24, thereby enabling generation of solid low sounds and clear mid and high sounds and thus providing good acoustic characteristics. Moreover, the tone control holes 27 enable appropriate control of tones in a desired frequency band.

Further, the surface opposed to the driver unit 41 in the rear space 24 is a flat surface. The rear space 24 has the rear air duct 28 which opens facing laterally and the front space 21 has the front air duct 25 which opens facing forward. This enables the correction of sound distortion and echo and enables reduction in a load on the diaphragm of the driver unit 41.

Further, the outline of the casing 11 and the outline of the external auditory meatus insertion member attached to the casing 11 are axisymmetric with respect to the axis extending in the longitudinal direction. This enables the generation of undistorted sounds.

Moreover, the ear pad 50 includes the cylindrical body portion 51, in the center of which the pad sound guide hole 61 is formed, and the cap portion 53, which is connected to the tip of the body portion 51 and slantingly spreads from the tip of the body portion 51 toward the rear end thereof. The cap portion 53 includes the plurality of slit-shaped openings 62 radially extending when viewed from the tip side of the body portion 51, and the body portion 51 includes the pad grooves 63 axially extending and formed in the places respectively corresponding to the openings 62 in the outer peripheral surface of the body portion 51. The openings 62 overlap with the pad grooves 63 corresponding thereto when the cap portion 53 is deformed and pressed against the outer peripheral surface of the body portion 51.

Thus, the communication between the inside and the outside of the external auditory meatus is maintained even in cases where the cap portion 53 is deformed and pressed against the outer peripheral surface of the body portion 51 when the ear pad 50 is inserted into the external auditory meatus. Accordingly, external environmental sounds such as an alarm impinge on the inside of the external auditory meatus and reach the eardrum, and therefore the safety is not reduced. Moreover, the air in the external auditory meatus is vented to the outside through the openings 62, thereby reducing the sense of pressure, muffled feeling, and the like of the sounds which impinge on the inside of the external auditory meatus from the earphone 10. This improves the sharpness of low sounds and provides clear mid and high sounds. Further, sounds from the earphone 10 do not press the eardrum and therefore the earphone 10 is favorable to the health.

Further, the ear piece 70 is made of metal and includes the cylindrical body portion 71, in the center of which the piece sound guide hole 73 is formed, and the bulge 74, whose outer surface slantingly spreads from the tip of the body portion 71 toward the rear end thereof. When inserted into the external auditory meatus, the bulge 74 deforms at least a part of the inner surface of the external auditory meatus. This provides good wearing feeling and fit feeling and makes low sounds sharp and mid and high sounds clear. Moreover, when the bulge 74 is inserted into the external auditory meatus, the piece sound guide hole 73 is not deformed. Therefore, the sounds from the driver unit 41 impinge on the external auditory meatus without sound distortion and good sound quality is provided.

The Present Application is applicable to an earphone having an external auditory meatus insertion member at least a part of which is inserted into an external auditory meatus.

While a preferred embodiment of the Present Application is shown and described, it is envisioned that those skilled in the art may devise various modifications without departing from the spirit and scope of the foregoing Description and the appended Claims.

What is claimed is:

1. An earphone (10) comprising:
an external auditory meatus insertion member at least a part of which is insertable into an external auditory meatus;
a casing (11) from which the external auditory meatus insertion member is detachable; and
a driver unit (41) which is disposed within the casing (11) to generate sounds;
wherein the external auditory meatus insertion member includes an elastically deformable soft insertion member (50) and a highly rigid hard insertion member (70).

2. The earphone (10) of claim 1, wherein the soft insertion member (50) and the hard insertion member (70) are selectively attached to the casing (11).

3. The earphone (10) of claim 2, wherein the casing (11) is made of metal and includes a truncated cone-like front space (21), which is formed in front of the driver unit (41), a sound guide hole (22), which is in communication with a front end of the front space (21) to cause sounds to impinge on the external auditory meatus, and a cylindrical rear space (24), which is formed behind the driver unit (41).

4. The earphone (10) of claim 3, wherein the rear space (24) includes a tone control hole (27), which opens facing laterally.

5. The earphone (10) of claim 4, wherein:
a surface opposed to the driver unit (41) in the rear space (24) is a flat surface;
the rear space (24) has an air control hole (28) which opens facing laterally; and
the front space (21) has an air control hole (25) which opens facing forward.

6. The earphone (10) of claim 5, wherein the outline of the casing (11) and the outline of the external auditory meatus insertion member attached to the casing (11) are axisymmetric with respect to an axis extending in a longitudinal direction.

7. The earphone (10) of claim 6, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

8. The earphone (10) of claim 1, wherein the outline of the casing (11) and the outline of the external auditory meatus insertion member attached to the casing (11) are axisymmetric with respect to an axis extending in a longitudinal direction.

9. The earphone (10) of claim 8, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

10. The earphone (10) of claim 8, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.

11. The earphone (10) of claim 1, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

12. The earphone (10) of claim 1, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.

13. The earphone (10) of claim 2, wherein the outline of the casing (11) and the outline of the external auditory meatus insertion member attached to the casing (11) are axisymmetric with respect to an axis extending in a longitudinal direction.

14. The earphone (10) of claim 13, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

15. The earphone (10) of claim 13, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.

16. The earphone (10) of claim 2, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

17. The earphone (10) of claim 2, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.

18. The earphone (10) of claim 3, wherein:
the soft insertion member (50) includes a cylindrical body portion (51), in the center of which a sound guide hole (61) is formed, and an elastically deformable portion (53), which is connected to the tip of the body portion (51) and slantingly spreads from the tip of the body portion (51) toward the rear end thereof;
the elastically deformable portion (53) includes a plurality of slit-shaped openings (62) radially extending when viewed from the tip side of the body portion (51); and
the body portion (51) includes grooves (63) axially extending and formed in places respectively corresponding to the openings (62) in an outer peripheral surface of the body portion (51); and
the openings (62) overlap with the grooves (63) corresponding thereto in a state where the elastically deformable portion (53) is deformed and pressed against the outer peripheral surface of the body portion (51).

19. The earphone (10) of claim 3, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.

20. The earphone (10) of claim 4, wherein:
the hard insertion member (70) is made of metal and includes a cylindrical body portion (71), in the center of which a sound guide hole (73) is formed, and a bulge (74) whose outer surface slantingly spreads from the tip of the body portion (71) toward the rear end thereof; and
the bulge (74) deforms at least a part of the inner surface of the external auditory meatus when inserted into the external auditory meatus.
